(19) United States
(12) Patent Application Publication
(10) Pub. No.: US 2007/0171231 A1
(43) Pub. Date: Jul. 26, 2007

(54) Image display controlling device and image display controlling method

(75) Inventors: Atsushi Yamada, Kawasaki (JP); Yuji Tajima, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/429,155

(22) Filed: May 8, 2006

(30) Foreign Application Priority Data
Jan. 20, 2006 (JP) 2006-012033

(51) Int. Cl. G06T 1/60

(52) U.S. Cl. 345/530

(57) ABSTRACT

A data buffer unit retains unit data sequentially decoded by a JPEG decoder. The data buffer unit has memory capacity equal to or larger than capacity required for storing unit data and smaller than capacity required for storing a screenful of image data on a display device. A data output control unit sequentially reads the unit data sequentially retained in the data buffer unit, and outputs the read unit data to the display device together with data indicating display positions on the display device. Thus, image data decoded by the JPEG decoder can be outputted to the display device without a frame buffer of large memory capacity. Accordingly, it is possible to reduce the cost for an image display controlling device which displays images on a display device.

### CROSS REFERENCE TO RELATED APPLICATION

This application is based upon and claims the benefit of priority from Japanese Patent Application No. 2006-012033, filed on Jan. 20, 2006, the entire contents of which are incorporated herein by reference.

### BACKGROUND OF THE INVENTION

1. Field of the Invention

The present invention relates to an image display controlling device and an image display controlling method for displaying JPEG stream data on a display device.

2. Description of the Related Art

Before displayed on a display device such as an LCD (liquid crystal display), JPEG stream data is decoded by a JPEG decoder and stored in a frame buffer. The frame buffer stores therein a screenful of image data on the display device, for example. An LCD controller sequentially reads image data corresponding to display lines of the LCD from the frame buffer, and sequentially outputs the read image data to the LCD (so-called line-sequential scanning). Through these processes, desired images can be displayed on the LCD (for example, see Japanese Unexamined Patent Application Publication No. 2005-31482).

As apparent from above, a screenful of decoded image data is temporarily written to the frame buffer, and subsequently read from the frame buffer. Thus, the frame buffer is required to have memory capacity at least large enough to retain a screenful of image data. Recently, the number of pixels has been increasing in large-sized LCDs along with increases in memory capacity of the frame buffer. Accordingly, the cost for the device for displaying images rises. Meanwhile, the dimensions of LCDs used in mobile phones, digital cameras, portable computer games are several inches, and the frame buffer has also been needed to display images on such small-sized LCDs. Thus, the additional cost for the components associated with the frame buffer incurs, increasing the cost for the device for displaying images.

### SUMMARY OF THE INVENTION

It is an object of the invention to reduce cost of an image display controlling device displaying JPEG stream data on a display device.

According to an aspect of the invention, a data buffer unit retains unit data sequentially decoded by a JPEG decoder. The data buffer unit has memory capacity equal to or larger than capacity to store unit data and smaller than capacity to store a screenful of image data on a display device. A data output control unit sequentially reads unit data retained sequentially in the data buffer unit, and outputs the read unit data to the display device together with data indicating display positions on the display device. Thus, image data decoded by the JPEG decoder can be outputted to the display device without a frame buffer of large memory capacity. Accordingly, it is possible to reduce the cost for an image display controlling device which displays images on the display device.

According to a preferable example of the aspect of the invention, a JPEG decoder sequentially decodes JPEG-encoded stream data into unit data and outputs the unit data to the data buffer unit. The data output control unit controls transfer of unit data from the data buffer unit to the display device and writing of new unit data to the data buffer unit, in accordance with the unit data output operation of the JPEG decoder. Thus, unit data can be outputted sequentially under the control of the data output control unit without loss of any unit data. The capacity of the data buffer unit can be decreased to a minimum, thereby reducing the cost for the image display controlling device.

According to a preferable example of the aspect of the invention, unit data is pixel data for displaying an image in a rectangular area formed of a plurality of pixel lines. The data output control unit repetitively outputs image data corresponding to one line of the unit data and output of start position data a number of times equal to a total number of lines of the unit data. The start position data indicates a position to start a display of the one line of the unit data. Performing so-called line-sequential scanning for each unit data makes it possible to output image data to the display device without using a frame buffer.

According to a preferable example of the aspect of the invention, unit data is MCU (minimum code unit) data. Using MCU data as standard unit of JPEG data as unit data enables the use of currently available circuits such as a JPEG decoder. Accordingly, the design cost can be reduced as well as the cost for the image display controlling device.

According to a preferable example of the aspect of the invention, the memory capacity of the data buffer unit is equal to the memory capacity to store unit data. Accordingly, the size of the data buffer unit can be decreased to a minimum, thus the cost for the image display controlling device can be reduced.

According to a preferable example of the aspect of the invention, an overlay unit receives data to be overlaid and unit data outputted from the data buffer unit, and overlays the received data to be overlaid on the unit data. The data output control unit sequentially outputs the overlay data overlaid by the overlay unit to the display device. Thus, data to be overlaid can be overlaid on each unit data and outputted to the display device. Accordingly, it is possible to reduce the cost for the image display controlling device capable of overlaying images.

According to a preferable example of the aspect of the invention, an overlay buffer unit retains data to be overlaid. The data output control unit sequentially transfers data to be overlaid retained in the overlay buffer unit to the overlay unit, in synchronization with unit data readout from the data buffer unit. This enables data to be overlaid to be accurately overlaid on each unit data.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing a first embodiment according to the invention;

FIG. 2 is a block diagram showing an example of a system on which a liquid crystal controller shown in FIG. 1 is provided;

FIG. 3 is an explanatory view showing pixels on a liquid crystal panel shown in FIG. 1;

FIG. 4 is a timing chart showing operation of a data output control unit shown in FIG. 1;

FIG. 5 is a block diagram showing a second embodiment according to the invention; and

FIG. 6 is a timing chart showing operation of a liquid crystal controller shown in FIG. 5.

### DESCRIPTION OF THE PREFERRED EMBODIMENTS

Embodiments according to the invention are hereinafter described with reference to the accompanying drawings. Reference signs similar to signal names are given to signal lines through which the corresponding signals are transmitted.

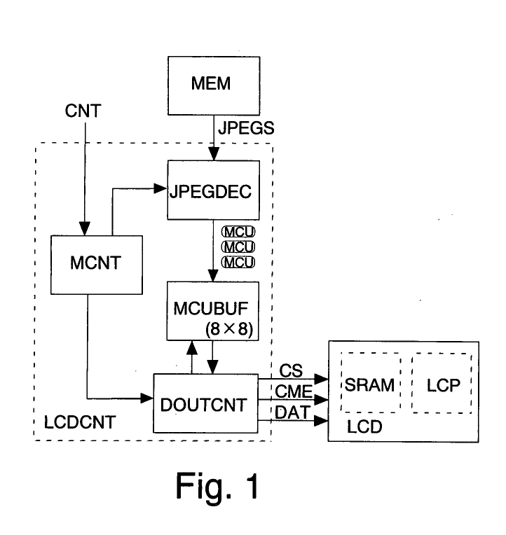

FIG. 1 shows a first embodiment according to the invention. An image display controlling device LCDCNT (liquid crystal controller; hereinafter also referred to as controller LCDCNT) in this embodiment receives JPEG stream data JPEGS outputted from a data memory unit MEM, and outputs image data to a liquid crystal display device LCD together with control signals. The controller LCDCNT has a main control unit MCNT, a JPEG decoder JPEGDEC, a data buffer unit MCUBUF (hereinafter also referred to as MCU buffer), and a data output control unit DOUTCNT.

The main control unit MCNT receives control signals CNT from outside, and controls the decoding operation of the decoder JPEGDEC and the operation of the data output control unit DOUTCONT. The main control unit MCNT may be disposed outside the controller LCDCNT. The decoder JPEGDEC receives JPEG-encoded stream data from the data memory unit MEM, and sequentially decodes the received data into non-encoded data (RGB data in this embodiment). The non-encoded data is divided into unit data which is generally referred to as MCU (minimum code unit) data. The MCU buffer sequentially retains the decoded MCU data. According to the invention, image data to be displayed on the LCD is processed by unit of MCU as standard unit of JPEG data. This enables the use of circuits having been already developed such as the decoder JPEGDDEC. Accordingly, the design cost can be reduced and thus the cost for the image display controlling device LCDCNT can be lowered.

In this embodiment, the decoder JPEGDEC sequentially produces and outputs MCU data which contains 8×8 pixels (length×transverse). The memory area of the MCU buffer is equal to the area for storing one MCU data (memory area required to store image data for displaying 64 pixels). Thus, MCU data outputted from the decoder JPEGDEC can be written to the MCU buffer only after MCU data is transferred from the MCU buffer to the data output control unit DOUTCNT so as to prevent overwriting of data.

The data control output unit DOUTCNT writes MCU data outputted from the decoder JPEGDEC to the MCU buffer under the control of the main control unit MCNT, and reads MCU data from the MCU buffer. In other words, the data output control unit DOUTCNT controls transfer timing for transferring MCU data from the MCU buffer to the LCD, and writing timing for writing new MCU data to the MCU buffer, both in synchronization with the operation for outputting MCU data by the decoder JPEGDEC. By the control of the data control output unit DOUTCNT, overwriting of new MCU data on MCU data retained in the MCU buffer can be prevented. Thus, the data output control unit DOUTCNT can sequentially output MCU data to the LCD without losing MCU data.

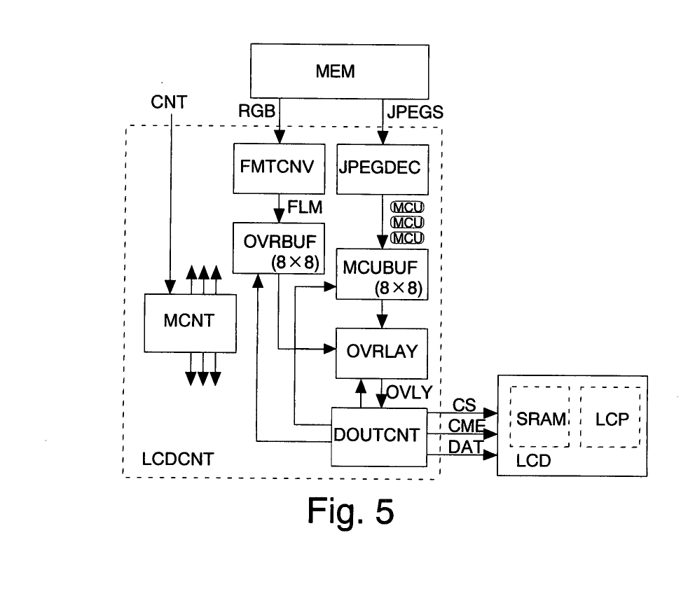

The data output control unit DOUTCNT sequentially receives display addresses (display positions) on the LCD from the main control unit MCNT. The data output control unit DOUTCNT outputs the read MCU data and display addresses to the liquid crystal display device LCD according to predetermined protocols. More specifically, the data output control unit DOUTCNT outputs chip select signals CS, command enable signals CME, and data signals DAT to the liquid crystal display device LCD. The operation of the data output control unit DOUTCNT will be described later with reference to FIG. 5.

The liquid crystal display device LCD has a liquid crystal panel LCP containing 320×3(RGB)×240 pixels, for example, and an SRAM for storing a screenful of image data to be displayed on the liquid crystal panel LCP. The memory area of the SRAM is allocated in correspondence with the pixels on the liquid crystal panel LCP. Thus, when image data is written to any address of the SRAM by the data output control unit DOUTCNT, an image is displayed on pixels corresponding to this address on the liquid crystal panel LCP. This type of liquid crystal display device LCD is also referred to as an asynchronous liquid crystal display device (asynchronous liquid crystal panel). A synchronous liquid crystal display device needs to receive images synchronously with the scan timing of images to be taken into the device. Thus, a number of requirements to be satisfied are imposed on the device for transmitting images to the liquid crystal display device. However, in case of the asynchronous liquid crystal display device, such a requirement that images are transmitted to the liquid crystal display device synchronously with its scan timing of images is not required to be satisfied by the device for transmitting images to the liquid crystal display device. Thus, the asynchronous liquid crystal display device is very compatible with the invention which transfers images by each unit data to which position data.

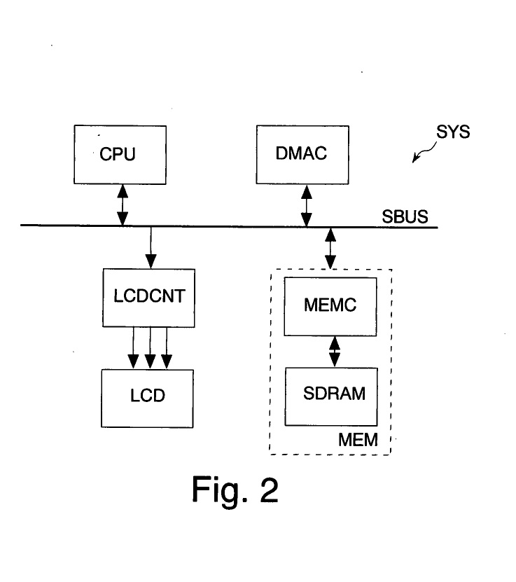

FIG. 2 shows an example of a system SYS on which the liquid crystal controller LCDCNT shown in FIG. 1 is provided. For example, the system SYS constitutes a part of a mobile phone, a digital camera, a portable computer game or the like. The system SYS has a CPU connected with a system bus SBUS, a DMAC, the controller LCDCNT, and the data memory unit MEM. The CPU controls the overall operation of the system SYS. The DMAC is used to transmit data from the data memory unit MEM to the controller LCDCNT or for other purpose. The data memory unit MEM is constituted of a memory controller MEMC and an SDRAM, for example.

According to the invention, the frame buffer for temporarily retaining image data to be displayed on the LCD is not needed, as will be described later. Since connection of the frame buffer to the system bus SBUS is not required, the usage rate of the system bus SBUS can be improved, and thus the performance of the system SYS can be improved. Moreover, since data transfer between the frame buffer and the controller LCDCNT is not needed, the frequency of operation of the DMAC can be decreased, and thus the power consumption of the system SYS can be lowered.

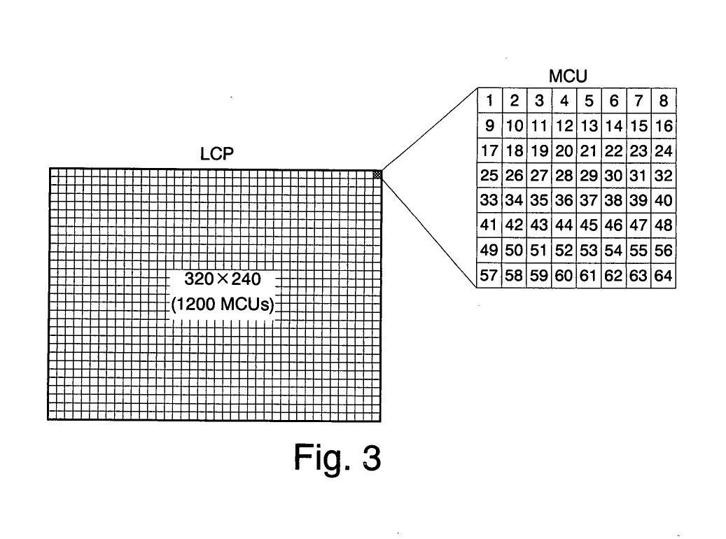

FIG. 3 shows pixels contained on the liquid crystal panel LCP shown in FIG. 1. In practical cases, pixels are formed for each of red (R), green (G), and blue but only pixels for one of R, G, and B are shown in the figure. Each pixel data in the MCU data (any of pixels 1 through 64 in the figure) contains information on R, G, or B. The MCU data is a collection of pixel data used for displaying an image in a square area constituted of a plurality of pixel lines.

The resolution of the liquid crystal panel LCP is 320 pixels×240 pixels (76,800 pixels; transverse×length). Thus, a screenful of data on the liquid crystal panel LCP is constituted of 1,200 MCU data. Prior to this invention, a frame buffer for storing 1,200 MCU data were required. However, only the MCU buffer for storing image data containing 64 pixels is needed to display images on the liquid crystal panel LCP according to the invention. As a result, the memory capacity required for temporarily retaining the decoded MCU data can be reduced to 1/1,200 of the memory capacity in the related art. Therefore, the frame buffer is not required and thus the cost for the system SYS can be reduced.

The data output control unit DOUTCNT outputs the MCU data read from the MCU buffer line by line to the liquid crystal panel LCP eight times in total. More specifically, the data output control unit DOUTCNT sequentially outputs pixel data 1-8, 9-16, 17-24, through 57-64, each corresponding to one line of the MCU data, to the liquid crystal panel LCP.

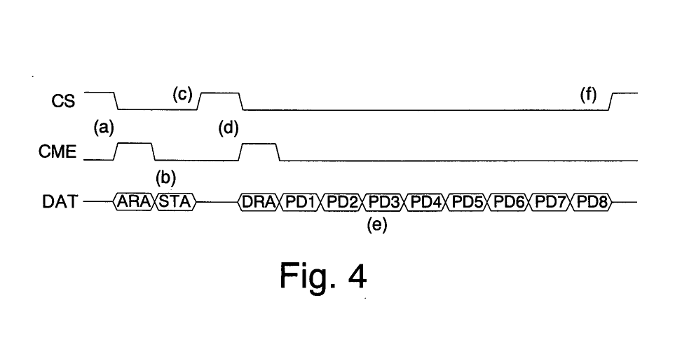

FIG. 4 shows the operation of the data output control unit DOUTCNT shown in FIG. 1. The chip select signals CS are effective when they are low level signals. The command enable signals CME are effective when they are high level signals.

The data output control unit DOUTCNT asserts the CS signals as low level and the CME signals as high level, and outputs an address resister access command ARA to a data signal line DAT while asserting the CME signals (FIG. 4(a)). The ARA command is a command for notifying the liquid crystal display device LCD that a start address for starting image display is to be supplied. The data output control unit DOUTCNT negates the CME signals as low level, and then outputs a start address STA to the data signal line DAT (FIG. 4(b)). The start address STA indicates the positions (coordinates) of the pixels on the liquid crystal panel LCP as start position data showing the position from which one line of the MCU data starts to be displayed. More specifically, the start address STA indicates any coordinates on one row at the left end in the MCU data shown in FIG. 3 (any of Nos. 1, 9, 17, through 49, 57; No. 1 in this example). Then, the CS signals are negated as high level (FIG. 4(c)). The liquid crystal display device LCD recognizes the data signals DAT received subsequent to the ARA command as the start address STA.

Thereafter, the data output control unit DOUTCNT again asserts the CS signals and CME signals, and outputs a data resister access command DRA to the data signal line DAT while asserting the CME signals (FIG. 4(d)). The DRA command is a command for notifying the liquid crystal display device LCD that image data is to be supplied. The data output control unit DOUTCNT negates the CME signals, and then sequentially outputs image data PD1, PD2, PD3, through PD7, and PD8 for eight pixels to the data signal line DAT in synchronization with the CS signals (FIG. 4(e)). For example, the pixel data PD1 through PD8 correspond to the first line (Nos. 1 through 8) of the MCU data shown in FIG. 3. After outputting the pixel data PD1 through PD8 for eight pixels, the data output control unit DOUTCNT negates the CS signals (FIG. 4(f)).

Through the above operation, an image is displayed on the eight pixels (one line of MCU data) of the liquid crystal panel LCP. This operation is repeated eight times with different start addresses STA and image data to display an image on 64 pixels (MCU data) of the liquid crystal panel LCP. That is, so-called line-sequential scanning is performed for each MCU data. By outputting the MCU image data 1,200 times in accordance with the operation of the decoder JPEGDEC in the manner described above, a screenful of data is displayed on the liquid crystal panel LCP.

In the first embodiment discussed above, image data decoded by the decoder JPEGDEC can be outputted to the LCD by using the MCU buffer in place of the frame buffer. As a result, the capacity of the memory (MCU buffer) for temporarily retaining the decoded MCU data can be decreased to the minimum, and thus the cost for the image display controlling device LCDCNT for displaying the image data on the LCD can be reduced.

Since the frame buffer is not required, the need for connecting the frame buffer to the system bus SBUS is eliminated. Thus, the usage rate of the system bus SBUS can be reduced. Accordingly, the system bus SBUS can be used for other operations in the system, which improves the performance of the system SYS. Moreover, since data transfer between the frame buffer and the controller LCDCNT is unnecessary, the operation frequency of the DMAC can be decreased and thus the power consumption of the system SYS can be reduced. Particularly, in the related art, non-encoded data which has been decoded is transferred between the frame buffer and the controller LCDCNT. As a result, the usage rate of the system bus SBUS tends to increase compared with the usage rate in case of encoded JPEG stream data transfer. Therefore, reduction in the usage rate of the system bus SBUS in this embodiment offers considerable advantages.

FIG. 5 shows a second embodiment according to the invention. In this embodiment, similar reference signs are given to elements similar to those shown in the first embodiment, and detailed explanation of those elements is not repeated herein. The data output control unit DOUTCNT in this embodiment has a format converter FMTCNV, an overlay buffer OVRBUF, and an overlay unit OVRLAY as well as the components included in the data output control unit DOUTCNT in the first embodiment. The data memory unit MEM stores JPEG stream data JPEGS and RGB data to be overlaid on image data. The RGB data is frame data such as illustrations for decorating images to be displayed on the liquid crystal display device LCD, for example. The main control unit MCNT has a function for controlling operation of the format converter FMTCNV as well as the control function of the main control unit used in the first embodiment. The liquid crystal controller LCDCNT is provided on the system SYS having a structure similar to that of the system SYS shown in FIG. 2, for example.

The format converter FMTCNV converts the RGB data read from the data memory unit MEM into frame data FLM (RGB data; data to be overlaid) corresponding to MCU data. The frame data FLM converted in correspondence with MCU data is written to the overlay buffer OVRBUF in synchronization with the time when MCU data is stored in the MCU buffer. The frame data FLM is written to the overlay buffer OVRBUF under control of the data output control unit DOUTCNT.

The overlay buffer unit OVRBUF has the same memory capacity as that of the MCU buffer. Thus, the overlay buffer OVRBUF can store frame data FLM for 64 pixels. The overlay unit OVRLAY overlays frame data FLM outputted from the overlay buffer OVRBUF on MCU data outputted from the MCU buffer, and outputs overlay image data OVLY to the data output control unit DOUTCNT. The frame data FLM is transferred from the overlay buffer OVRBUF to the overlay unit OVRLAY under control of the data output control unit DOUTCNT. In other words, the data output control unit DOUTCNT sequentially transfers the frame data FLM retained in the overlay buffer unit OVRBUF to the overlay unit OVRLAY in synchronization with the time when the MCU data is read from the MCU buffer. Then, the data output control unit DOUTCNT sequentially reads the overlay image data OVLY as MCU data from the overlay unit OVRLAY, and outputs the overlay image data OVLY to the LCD. The operation for outputting the image data OVLY from the data output control unit DOUTCNT to the LCD is similar to that in the first embodiment (FIG. 4).

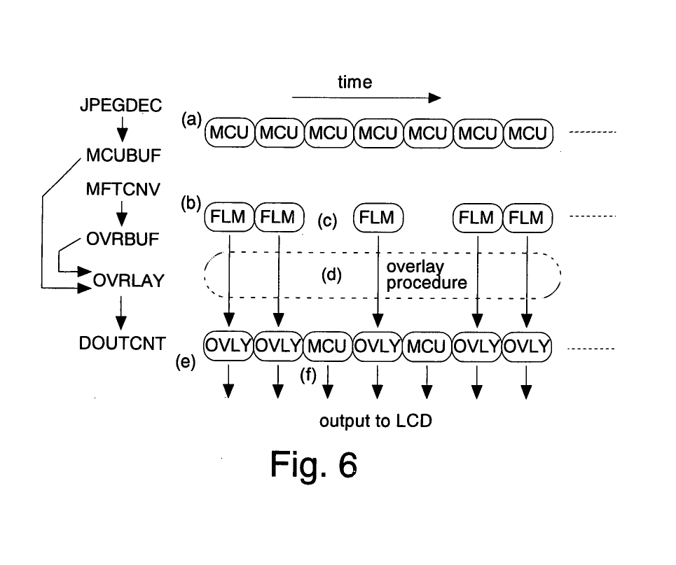

FIG. 6 shows operation of the liquid crystal controller LCDCNT shown in FIG. 5. The MCU buffer sequentially retains MCU data decoded by the JPEG decoder in the same manner as in the first embodiment (FIG. 6(a)). The overlay buffer OVRBUF sequentially retains frame data FLM converted by the format converter FMTCNV (FIG. 6(b)). The format converter FMTCNV does not output frame data FLM when no flame data FLM to be overlaid on MCU data exists. In this case, the overlay buffer OVRBUF does not receive frame data FLM (FIG. 6(c)). Then, the overlay unit OVRLAY overlays frame data FLM on MCU data (FIG. 6(d)). The data output control unit DOUTCNT receives overlay data OVLY obtained after overlay procedure by the overlay unit OVRLAY, and outputs the received overlay data OVLY to the LCD (FIG. 6(e)). When no corresponding frame data FLM exists, only MCU data is outputted to the liquid crystal display device LCD (FIG. 6(f)).

In the second embodiment, advantages similar to those in the first embodiment can be offered. Moreover, in this embodiment, frame data FLM can be overlaid on each MCU data and resultant overlay data can be outputted to the LCD. Accordingly, the cost for the image display controlling device LCDCNT capable of overlaying images can be reduced.

Furthermore, frame data FLM can be transferred to the overlay unit OVRLAY in synchronization with the time when MCU data is read from the MCU buffer under the control of the data output control unit DOUTCNT. Thus, frame data FLM can be accurately overlaid on each MCU data.

In the embodiments described herein, the size of the memory capacity of the MCU buffer is so determined as to be equivalent to the volume required for storing one MCU data (image data volume for displaying 64 pixels). However, the invention is not limited to those embodiments. For example, the size of the memory capacity of the MCU buffer may be equivalent to the volume required for storing approximately 2 to 10 MCU data. When a plurality of MCU data are retainable in the MCU buffer, the main control unit MCNT and the data output control unit DOUTCNT can be easily controlled. Since the memory capacity of the MCU buffer is smaller than the memory capacity of the frame buffer in the related art, the cost for manufacturing the liquid crystal controller LCDCNT can be reduced to be smaller than that cost required in the related art.

In the embodiments described herein, the data memory unit MEM constituted of the memory controller MEMC and the SDRAM is used. However, the invention is not limited to those embodiments. The data memory unit MEM may have other structures as long as it can store JPEG stream data. For example, the data memory unit MEM may be constituted of a memory controller and a flash memory. Alternatively, the data memory unit MEM may be formed of a memory card or a hard disk device.

In the embodiments described herein, the invention is applied to the image display controlling device for decoding JPEG stream data JPEGS which is formed of encoded RGB data. However, the invention is not limited to the embodiments but is applicable to an image display controlling device for decoding JPEG stream data JPEGS which is formed of encoded YUV data. In this case, the data output control unit DOUTCNT is required to have a function for converting YUV data into RGB data, for example.

The invention is not limited to the above embodiments and various modifications may be made without departing from the spirit and scope of the invention. Any improvement may be made in part or all of the components.

What is claimed is:

1. An image display controlling device, comprising:
a data buffer unit which has memory capacity equal to or larger than capacity to store unit data and smaller than capacity to store a screenful of image data on a display device, and retains the unit data sequentially decoded by a JPEG decoder; and
a data output control unit which sequentially reads the unit data retained sequentially in said data buffer unit, and outputs read unit data to said display device together with data indicating display positions on said display device.

2. The image display controlling device according to claim 1, further comprising
a JPEG decoder sequentially decoding JPEG-encoded stream data into unit data and outputting the unit data to said data buffer unit, wherein
said data output control unit controls transfer of the unit data from said data buffer unit to said display device and writing of new unit data to said data buffer unit, in accordance with the unit data output operation of said JPEG decoder.

3. The image display controlling device according to claim 1, wherein:
the unit data is pixel data for displaying an image in a rectangular area formed of a plurality of pixel lines; and
said data output control unit repetitively outputs image data corresponding to one line of the unit data and start position data a number of times equal to a total number of lines of the unit data, the start position data indicating a position to start a display of the one line of the unit data.

4. The image display controlling device according to claim 1, wherein the unit data is MCU data.

5. The image display controlling device according to claim 1, wherein
the memory capacity of said data buffer unit is equal to the memory capacity to store the unit data.

6. The image display controlling device according to claim 1, further comprising
an overlay unit receiving data to be overlaid and the unit data outputted from said data buffer unit, and overlaying received data to be overlaid on the unit data, wherein
said data output control unit sequentially outputs overlay data overlaid by said overlay unit to said display device.

7. The image display controlling device according to claim 6, further comprising
an overlay buffer unit retaining the data to be overlaid, wherein
said data output control unit sequentially transfers the data to be overlaid retained in said overlay buffer unit to said overlay unit, in synchronization with unit data readout from said data buffer unit.

8. An image display controlling method, comprising the steps of:
retaining unit data decoded sequentially by a JPEG decoder in a data buffer unit which has memory capacity equal to or larger than capacity to store the unit data and smaller than capacity to store a screenful of image data on a display device; and
sequentially reading the unit data retained sequentially in said data buffer unit, and outputting read unit data to said display device together with data indicating display positions on said display device.

9. The image display controlling method according to claim 8, further comprising the step of
controlling transfer of the unit data from said data buffer unit to said display device and writing of new unit data to said data buffer unit, in accordance with the unit data output operation of said JPEG decoder.

10. The image display controlling method according to claim 8, further comprising the step of
repetitively outputting image data corresponding to one line of the unit data and start position data a number of times equal to a total number of lines of the unit data, the start position data indicating a position to start a display of the one line of the unit data, wherein
the unit data is pixel data for displaying an image in a rectangular area formed of a plurality of pixel lines.

11. The image display controlling method according to claim 8, wherein the unit data is MCU data.

12. The image display controlling method according to claim 8, wherein the memory capacity of said data buffer unit is equal to the memory capacity to store the unit data.

13. The image display controlling method according to claim 8, comprising the steps of:
receiving data to be overlaid and the unit data outputted from said data buffer unit, and overlaying received data to be overlaid on the unit data; and
sequentially outputting overlaid overlay data to said display device.

14. The image display controlling method according to claim 13, further comprising the steps of
sequentially transferring the data to be overlaid retained in an overlay buffer unit to an overlay unit, in synchronization with unit data readout from said data buffer unit, wherein
the overlay unit overlays received data to be overlaid on the unit data.
